(19) United States
(12) Patent Application Publication
(10) Pub. No.: US 2026/0048751 A1
(43) Pub. Date: Feb. 19, 2026

(54) CONNECTED TWIN FRAMEWORK FOR ADAPTIVE CONTROL

(71) Applicant: Salesforce, Inc., San Francisco, CA (US)

(72) Inventors: Kusuma Kumari Seshavarapu, Hyderabad (IN); Abhilash Jena, Hyderabad (IN); Nagendra Kumar Vankadari, Hyderabad (IN); Naveen Kumar, Hyderabad (IN)

(73) Assignee: Salesforce, Inc., San Francisco, CA (US)

(21) Appl. No.: 18/977,819

(22) Filed: Dec. 11, 2024

(30) Foreign Application Priority Data
Aug. 15, 2024 (IN) 02441061963

(51) Int. Cl. B60W 50/00; G06Q 10/20; G06Q 30/0251

(52) U.S. Cl. CPC B60W 50/0097; G06Q 10/20; G06Q 30/0261

(57) ABSTRACT

A method for performing a dialog session including storing, in a memory a plurality of skills algorithms and a plurality of connected services in a memory, receiving, at a network interface, a first data indicative of a vehicle parameter, and a second data indicative of a vehicle location, and performing, by a processor, a digital twin algorithm to predict an operating condition of the vehicle in response to the first data, performing one of the plurality of skills in response to the operating condition and the second data to identify one of the connected services, and generating a control signal to initiate the connected service on a remote device.

### CROSS REFERENCE TO RELATED APPLICATIONS

The present application claims the filing benefits of Indian Provisional application number 02441061963 filed on 15 Aug. 2024.

### TECHNICAL FIELD

Embodiments of the subject matter described herein relate generally to integrated connected twin systems and algorithms. More particularly, embodiments of the subject matter relate to a method and apparatus for creating a digital model of a physical asset, implementing a bidirectional communications system in a digital model for receiving data reflective of a current state of the physical model, simulating a physical asset performance of the physical asset by the digital mode in response to the data, and communicating an instructional data to the physical asset in response to the simulated physical asset performance.

### BACKGROUND

Digital twins are sophisticated virtual replicas of physical assets or systems created by integrating real-time data from sensors and other sources with a detailed digital model. This integration provides a comprehensive understanding of the asset's current state, performance, and behavior. By continuously monitoring and analyzing the data collected from the physical asset, digital twins can identify potential issues and anomalies before they escalate into failures. This proactive approach enables predictive maintenance, where maintenance tasks are scheduled based on predicted needs rather than fixed intervals. This significantly reduces downtime, optimizes resource allocation, and extends the asset's lifespan.

Digital twins can be used to gain valuable insights into the root causes of issues and potential areas for improvement. By simulating various scenarios and analyzing the results, organizations can make informed decisions about maintenance strategies, upgrades, and replacements. This data-driven approach leads to more efficient operations, reduced costs, and improved overall asset performance. Additionally, digital twins can be used to optimize asset utilization, identify opportunities for energy efficiency, and enhance safety by simulating potential hazards and developing preventive measures. Accordingly, it is desirable to further develop the digital twin technology to advantageously use the generated results to further optimize physical asset utilization while minimizing the potential limitations. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows an exemplary environment or use of a digital twin in automotive applications according to an exemplary embodiment of the present disclosure;

FIG. 2 is a block diagram illustrative of a digital twin system for automotive applications according to an exemplary embodiment of the present disclosure; and

FIG. 3 is a flowchart illustrative of a method for implementing a digital twin system for automotive applications according to an exemplary embodiment of the present disclosure.

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

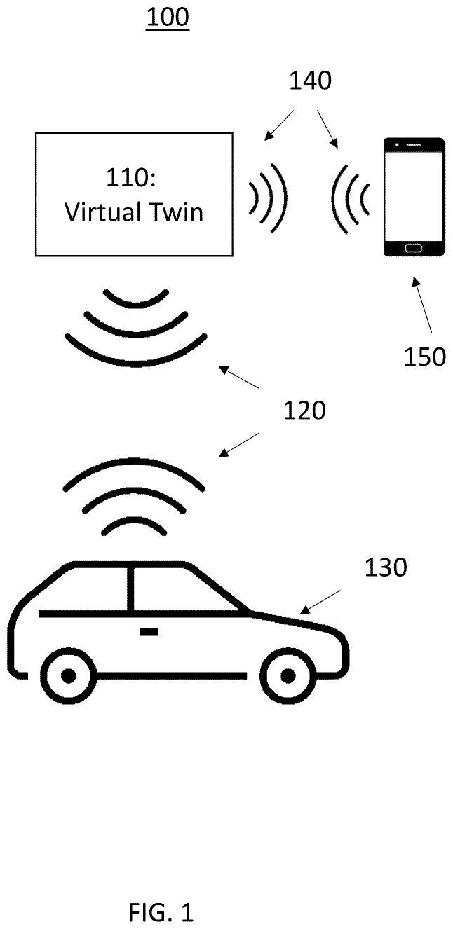

Turning now to FIG. 1, an exemplary environment 100 for use of a digital twin in automotive applications according to an exemplary embodiment of the present disclosure is shown. A digital twin is a virtual replica of a physical object or system that leverages real-time data and advanced analytics to mirror its behavior, performance, and state. By integrating Internet of Things (IoT) sensors, the digital twin collects and processes data from the physical asset, enabling it to simulate and predict its response to various conditions. Through the application of machine learning algorithms, the digital twin can identify patterns, anomalies, and potential failures, providing valuable insights for proactive maintenance and optimization. This technology empowers organizations to make data-driven decisions, enhance operational efficiency, and mitigate risks, ultimately leading to improved operational outcomes.

The exemplary environment 100 shows a digital twin used in an automotive application including an automotive digital twin 110 and a vehicle 130 in bidirectional communications 120. The automotive digital twin 110 is a virtual representation of the vehicle 130, encompassing its design, components, and real-time operational data. This automotive digital twin 110 employs the integration of advanced technologies, including simulation software, neural networks and artificial intelligence algorithms, as well as the IoT sensors. By merging these elements, service providers can gain a comprehensive understanding of a vehicles'performance, enabling data-driven decision-making and optimization across the automotive lifecycle, and providing proactive troubleshooting and related services and recommendations to drivers.

A critical technical aspect of a digital twin 110 involves the continuous collection and integration of real-time data via bidirectional communications 120 from the vehicle 130. Sensors embedded within the vehicle 130 transmit data on various parameters, such as engine performance, fuel consumption, tire pressure, and driver behavior. This data is then fed into the digital twin 110, allowing it to dynamically update and reflect the current state of the physical vehicle 130.

The digital twin 110 leverages sophisticated simulation software to create virtual environments that replicate real-world conditions. This enables testing, validation and identifies potential component failures or maintenance conditions of the vehicle systems under diverse scenarios, including extreme weather conditions, traffic congestion, and varying driving styles. By conducting virtual simulations, service providers can identify upcoming service requirements, component failures, optimize vehicle performance, and enhance safety features. The digital twin 110 serves as a powerful tool for predictive maintenance. By analyzing real-time data and historical performance patterns, the system can predict potential component failures and schedule maintenance proactively. These predictions can reduce vehicle downtime, minimizes unexpected breakdowns, and optimizes maintenance costs. Additionally, the digital twin 110 can be utilized to optimize supply chain logistics by predicting demand for spare parts and optimizing inventory levels.

In addition to predicting vehicle performance, the digital twin 110 can actively influence another physical asset, such as a mobile phone 150. For example. when a digital twin 110 is not tied to a vehicle 130, the digital twin 110 can communicate 140 with a wide range of devices, including mobile phones 150, infotainment systems and wearables. These separate device can then run applications to receive data from the digital twin 110 and to present information to a vehicle operator, such as warnings, recommendations, and/or offers. For example, based on vehicle location, vehicle condition, points of interest, and other conditions, warnings, offers and/or promotions can be made to the vehicle operator, or subscriptions could be enabled, such as finding a nearby electric vehicle charger, available and/or free parking spaces, and dining offers. A digital twin 110 can autonomously deploy self-healing algorithms, independent of the underlying provider. The digital twin 110 can interface with vehicle systems through an application programming interface (API), enabling bidirectional data exchange. This API, secured with granular permissions, controls access to specific actions. Users can configure orchestrations and even add custom actions. For instance, an OEM could initiate a targeted vehicle recall by defining specific criteria and triggering a batch process.

Digital twin systems offer a sophisticated command center for asset and vehicle management. By consolidating real-time data from diverse sources, this platform provides comprehensive health summaries, current state visualizations, and detailed event timelines. Advanced analytics and AI-driven insights offer valuable insights into asset performance and potential issues. The seamless integration of a connected service catalog empowers users to initiate maintenance, repair, or optimization actions directly from the command center. Furthermore, CRM integration with vehicle and asset data streamlines customer service and operational efficiency, optimizing asset lifecycle management.

While the current embodiment is presented in an automotive environment, the described novel framework is versatile enough to extend to diverse physical and digital assets, including human health. By incorporating biometric data such as heart rate, blood pressure, and body temperature from wearable devices, digital twins can accurately model an individual's physiological state, predict potential health risks, and personalize interventions. For example, the detection of abnormal heart rate patterns can trigger timely alerts for preventative measures. Additionally, biometric data can optimize athletic training regimens by analyzing performance metrics and tailoring workouts accordingly. The insights derived from these digital twins can also inform commercial offerings, such as personalized fitness plans and dietary recommendations. The integration of generative AI with digital twin systems offers a transformative approach to health summaries in connected environments. By analyzing real-time data from multiple sources, digital twins generate dynamic, personalized health profiles. Generative AI then processes this vast dataset to produce concise, actionable health summaries tailored to specific needs, empowering healthcare professionals, researchers, and individuals to make informed decisions based on comprehensive health insights.

Advantageously, the proposed digital twin systems can operate agnostically with multiple systems and system providers by adopting a flexible framework that seamlessly integrates with various systems and providers. By adopting an agnostic approach, the exemplary digital twin system can bidirectionally communicate with external sources, enabling their application across diverse industries. This versatility empowers digital twins to deliver valuable insights and drive optimization in various sectors.

Digital twin systems offer a robust platform for processing actionable events, streamlining operations, and reducing costs. Through continuous monitoring and analysis of real-time data from physical assets, digital twins can proactively identify anomalies, predict potential failures, and trigger timely interventions. This proactive approach minimizes downtime, optimizes resource allocation, and prevents costly disruptions. Additionally, digital twins can filter out irrelevant data, focusing on critical events and alerts, thereby enhancing operational efficiency. By leveraging advanced analytics and deep neural networks, digital twins can proactively identify potential issues, reducing downtime and maintenance costs.

Moreover, digital twin systems unlock substantial monetization opportunities within connected twin environments. By leveraging location-based data, businesses can implement targeted marketing strategies, personalized recommendations, and contextually relevant services. For instance, retailers can utilize digital twins to identify customers within their stores and offer tailored discounts or promotions based on their browsing history. Integrating commerce platforms into digital twin systems facilitates seamless transactions, such as virtual try-ons and direct purchases within the digital experience. These innovative approaches enable businesses to generate new revenue streams, enhance customer engagement, and drive growth in the connected twin economy.

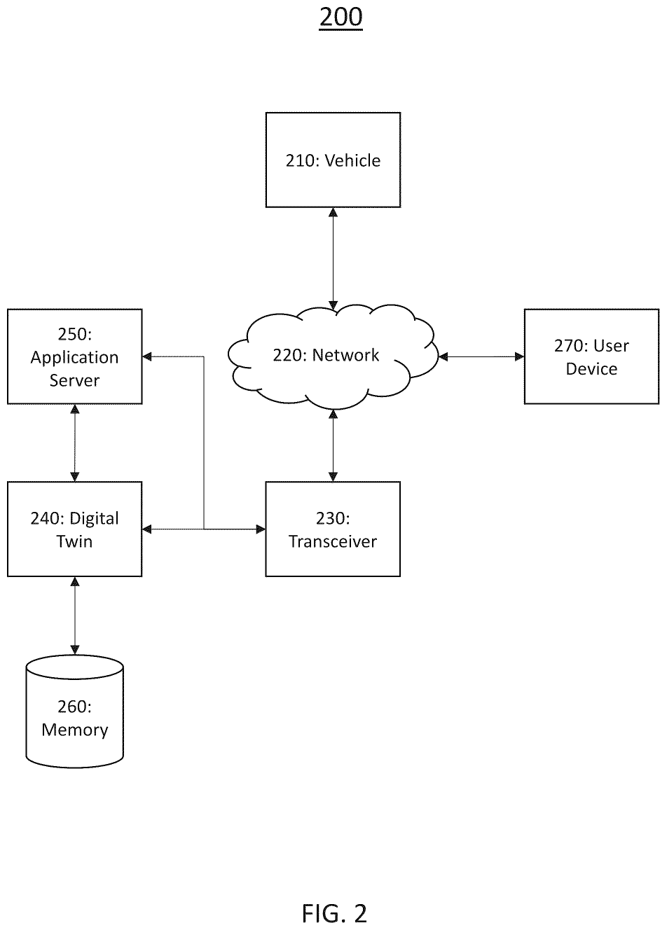

Turning now to FIG. 2, a block diagram illustrative of a digital twin system 200 for automotive applications according to an exemplary embodiment of the present disclosure is shown. This exemplary embodiment illustrates the digital twin system 200 within an automotive environment. However, the underlying systems and algorithms are versatile and can be adapted to a wide range of applications beyond the automotive industry. The exemplary digital twin system 200 can include a vehicle 210, a communications network 220, a transceiver 230, a digital twin 240, an application server 250, a memory 260 and a user device 270.

The vehicle 210, is a physical device operating within an actual physical environment and performing its intended function. As the vehicle 210 interacts with its environment, experiencing various conditions like weather, road quality, and traffic congestion, the vehicle's sensors collect data on its internal state, such as engine temperature, tire pressure, and external conditions, such as speed and location. This data is processed to control the vehicle's systems, including the engine, brakes, and steering, ensuring safe and efficient operation. As the vehicle 210 undergoes degradation over time, maintenance and repair to maintain optimal performance is required. Additionally, the vehicle 210 may encounter unforeseen events, such as accidents or breakdowns, which can impact its operation and necessitate immediate attention. Periodically, the vehicle 210 is configured to transmit this sensor data to the digital twin 240 via the communications network 220.

The transceiver 230 is configured to transmit and receive data from the vehicle 210 and the user device 160 and couple this data to and from the digital twin. In response to this data, the digital twin is configured to leverage the received data from the vehicle, such as engine performance, tire pressure, and vehicle location, as well as previously received data and simulation results related to the vehicle 210, stored in the memory 260 to create a detailed digital model of the vehicle, simulating the vehicle's behavior, predicting other vehicle conditions, and predicting potential failures. The digital twin 240 can further couple this data, as well as the simulation results, to an application server 250, or the like, to be used as input data for a recommendations algorithm.

The recommendation algorithm, performed by the application server 250, can be configured to predict potential service requirements of the vehicle 210, generate driver alert, notifications and warnings in response to the input data and other externally sourced data, such as maintenance schedules, predicted weather, vendor offers and promotion and the like. The application server 250 can then transmit these driver alert, notifications and warnings to the user device 160 via the transceiver 230 and/or the communications network 220. These recommendation algorithms, combined with bidirectional communication can enable addition services, including remote asset control, personalized user experiences, and novel revenue streams generated from data-driven insights.

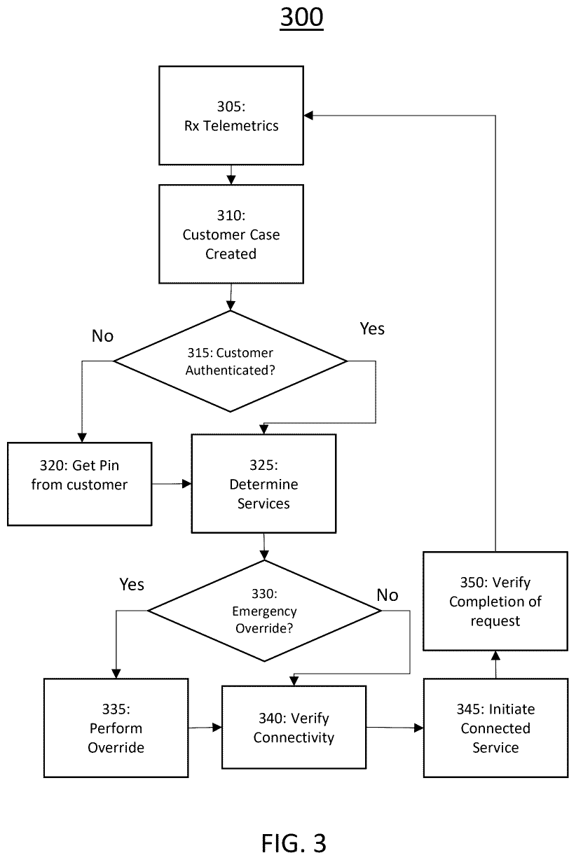

Turning now to FIG. 3, a flowchart of a method 300 for implementing a digital twin system for automotive applications according to an exemplary embodiment of the present disclosure is shown. The exemplary method 300 may be performed by a processor coupled to a network for receiving data from a plurality of devices and may include devices of different types and categories. The proposed method 300 is configured to enhance the existing digital twin concept by enabling bidirectional communication between digital and physical systems. This method 300 can be configured to be a device-agnostic configuration for connected twins and their services, allowing remote control through APIs, an event orchestration system for real-time response to IoT telematic events; comprehensive visualizations of device, performance, and operator metrics, and allows for data ingestion for predictive maintenance, health monitoring, and self-healing.

In some exemplary embodiments, the method 300 is first configured to receive 305 telemetrics data from the vehicle. The telemetrics data can include vehicle sensor data, engine performance, acceleration data, environmental data, and positional data, such as velocity and location. The method next creates 310 a customer case in response to the vehicle telemetrics. For example, the method 300 can be configured to automatically create customer calls or cases based on data collected from vehicle telematics systems. The algorithm analyzes the vehicle telemetric data to identify potential issues or anomalies that may require customer attention. For example, if the algorithm detects a significant drop in tire pressure or an engine malfunction, it can automatically generate a customer call or case to notify the customer of the issue and schedule necessary repairs.

In response to the creation of the customer case, the method 300 next determines 315 if a customer has been authenticated. If the customer has not been authenticated, the method 300 prompts 320 the customer for authentication information, such as a personal identification number (PIN) or a password. This authentication request can be sent to a mobile device or a vehicle infotainment system running an appropriate application or software. After receiving the authentication information, or in the case of prior authentication, the method next determines 325 the services to be provided to the user. These services can include services authorized by the user and/or services authorized by a subscription and/or service plan.

In response to the customer case and the determined services, the method 300 next determines 330 if an emergency override is required. If an emergency override is required the method 300 performs 335 the required override algorithm. An emergency override action in a digital twin can include pre-defined automated responses to a critical events that require immediate intervention. This action is designed to prevent potential damage, injuries, or other negative consequences. For example, in an automotive system, the method 300 can determine an anomalous increase in vibration levels in a critical component and a drastic increase in temperature, indicating a potential mechanical failure. The method 300 can then transmit a command to the vehicle to initiate a controlled shutdown to prevent catastrophic failure. A backup cooling system can activated to mitigate potential overheating.

In response to performing the override algorithm or determining an emergency override is not required, the method 300 next verifies 340 a connectivity to a user. The method 300 can determines a connectivity between the digital twin and/or application service to a mobile device over a wireless network through various methods. Primarily, the method 300 can utilize standard network protocols like TCP/IP to establish and maintain a connection. By sending and receiving data packets, the method 300 can assess the device's reachability and responsiveness. Alternatively, the method 300 can leverage technologies such as Wi-Fi Direct or Bluetooth to facilitate direct communication with the device, bypassing traditional network infrastructure. Furthermore, the method 300 can employ mobile network operators'signaling protocols to determine the device's network status and location, enabling more precise connectivity verification.

In response to a determination of the connectivity of the mobile device, the method 300 can initiate 345 the connected service algorithm. In some exemplary embodiments, the connected service algorithm can alert a user via automated notifications, detailing the issue and the actions taken. In addition, the method 300 can initiate a detailed diagnostic analysis of the vehicle to identify the root cause of the anomaly. The method 300 can then inform the user of the nature of the critical event and provide recommendations including repairs and scheduling preventive maintenance tasks to address the issue. Finally, the method 300 can verify 305 the completion of the request and return to receiving 305 the next telemetric data from the vehicle. In some exemplary embodiments, the verification of the completion of the request can include an error indication and/or a escalation request. In response to the error indication, the method 300 can transmit a request to a roadside assistance provider, such as a public service emergency assistance provider, a commercial third party service provider, an override verification and/or a request to enable a subscription or a purchase of a service package.

This example method 300 illustrates how a digital twin can proactively respond to critical events, minimizing downtime, and safeguarding equipment and personnel. This proactive approach can help to prevent more serious problems and improve customer satisfaction. The visualization framework offers a comprehensive view of the device's current status, including any active alerts. It also provides a catalog of remote actions that can be performed on the device, a history of past actions, and insights into both device and operator performance. The framework allows users to delve deeper into specific parameters and analyze historical trends. This metadata-driven framework is highly adaptable and can be easily configured for various parameters and devices.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The various tasks performed in connection with the process may be performed by software, hardware, firmware, or any combination thereof. For illustrative purposes, the following description of process may refer to elements mentioned above. In practice, portions of process may be performed by different elements of the described system, e.g., component A, component B, or component C. It should be appreciated that process may include any number of additional or alternative tasks, the tasks shown need not be performed in the illustrated order, and process may be incorporated into a more comprehensive procedure or process having additional functionality not described in detail herein. Moreover, one or more of the tasks shown could be omitted from an embodiment of the process as long as the intended overall functionality remains intact.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A non-transitory computer readable medium having computer instructions stored therein that when executed by a computer system to cause the computer system to perform operations for corresponding to a digital twin application comprising:
storing a database of a plurality of skills and a plurality of connected services associated with a plurality of operating conditions in a memory;
receiving a first data indicative of a system parameter, and a second data indicative of a system location;
performing a digital twin algorithm to predict a future operating condition of a system in response to the first data;
performing one of the plurality of skills in response to the future operating condition and the second data to identify one of the connected services; and
generating a control signal to initiate at least one of the connected services on a remote device in response to an identification of the at least one of the connected services.

2. The non-transitory computer readable medium of claim 1, wherein the system is a vehicle and first data is an engine temperature.

3. The non-transitory computer readable medium of claim 1, wherein each of the plurality of skills is associated with a skills vector stored on the memory and the one of the plurality of skills is determined in response to a closeness value between the skills vector and an operating condition vector.

4. The non-transitory computer readable medium of claim 1, wherein the remote device is a smartphone and wherein the at least one of the connected services is an algorithm stored within a device memory of the smartphone.

5. The non-transitory computer readable medium of claim 1, wherein the at least one of the connected services is operative to identify a service provider in response to the future operating condition and the vehicle location.

6. The non-transitory computer readable medium of claim 1, wherein the at least one of the connected services is a subscription service and wherein an initiation of the at least one of the connected services includes at least one of prompting a user to enable the subscription service and confirming a user subscription to the at least one of the connected services.

7. The non-transitory computer readable medium of claim 1, wherein the future operating condition is predicted in response to the first data, the second data, a previous first data and a previous second data.

8. The non-transitory computer readable medium of claim 1, wherein the first data includes at least one of an engine temperature, an error code, a vehicle speed, a vehicle acceleration, and a driver assessment.

9. The non-transitory computer readable medium of claim 1, wherein the the at least one of the connected services includes an indication of an availability of a promotion in response to the vehicle location.

10. A method for performing a digital twin algorithm in a vehicle application comprising:
storing, in a memory a plurality of skills algorithms and a plurality of connected services in the memory;
receiving, at a network interface, a first data indicative of a vehicle parameter, and a second data indicative of a vehicle location; and
performing, by a processor, the digital twin algorithm to predict a future operating condition of a vehicle in response to the first data, performing one of the plurality of skills algorithms in response to the future operating condition and the second data to identify a one of the connected services, and generating a control signal to initiate the one of the connected services on a remote device.

11. The method of claim 10 wherein the processor is further operative to determine a service requirement associated with the future operating condition, to generate a promotional data indicative of a service promotion in response to the service requirement and the vehicle location, and wherein the control signal includes the promotional data, and wherein the service promotion is presented to a user on the remote device in response to the control signal.

12. The method of claim 10 wherein the one of the connected services generates a prompt to a vehicle operator to perform an action on the vehicle.

13. The method of claim 10 wherein the one of the connected services includes scheduling a service operation for the vehicle.

14. The method of claim 10 wherein the remote device is a smartphone performing an algorithm and wherein the algorithm is in communication with the digital twin algorithm.

15. The method of claim 10 wherein the remote device is a vehicle infotainment system within the vehicle.

16. The method of claim 10 wherein the processor is further configured to generate a second control signal to couple to the vehicle to enable the vehicle to perform a corrective action in response to the future operating condition.

17. The method of claim 10 wherein the future operating condition is predicted using a convolutional neural network algorithm, the first data and a plurality of prior operations conditions associated with the first data detected in a plurality of vehicles.

18. The method of claim 10 wherein the one of the connected services includes at least one of a location based offer, a commerce integration and a personalized offer.

19. A computing system for implementing a digital twin algorithm, the computing system comprising:
a memory configured for storing a storing a plurality of data indicative of a plurality of connected services associated with a plurality of future operating conditions;
an network interface for receiving a first data indicative of a system parameter and a second data indicative of a system location and for coupling a control signal to a remote device;
performing, by a processor, the digital twin algorithm to predict a future operating condition of a system in response to the first data and the second data and to identify a one of the plurality of connected services, and generating the control signal indicative of the one of the plurality of connected services; and
the remote device for performing the one of the plurality of connected services in response to the control signal.

20. The computing system for implementing the digital twin algorithm of claim 19 wherein the system is a biological system and the first data is a biometric data and wherein the one of the plurality of connected services includes providing a medical instruction to a user and a proximate provider for providing a medical care procedure.
